(19) United States
(12) Patent Application Publication
(10) Pub. No.: US 2026/0302578 A1
(43) Pub. Date: Oct. 1, 2026

(54) BATTERY ASSEMBLY

(71) Applicant: SK On Co., Ltd., Seoul (KR)

(72) Inventors: Myeong Sub HAN, Daejeon (KR); Jae Kyung PARK, Daejeon (KR)

(21) Appl. No.: 19/575,929

(22) Filed: Mar. 24, 2026

(30) Foreign Application Priority Data
Mar. 27, 2025 (KR) 10-2025-0039593

(51) Int. Cl. H01M 50/691; H01M 50/505; H01M 50/557; H01M 50/581

(52) U.S. Cl. CPC H01M 50/691; H01M 50/505; H01M 50/557; H01M 50/581

(57) ABSTRACT

The present disclosure relates to a battery assembly, wherein the battery assembly according to an embodiment of the present disclosure may include: a housing having an accommodating space therein; a cell stack accommodated in the accommodating space inside the housing and including one or more battery cells; and a structure arranged between the battery cells and including a thermo-deformable member changing in volume at a predetermined temperature.

### CROSS-REFERENCE TO RELATED PATENT APPLICATION

The present application claims priority under 35 U.S.C. § 119(a) to Korean patent application number 10-2025-0039593 filed on Mar. 27, 2025, in the Ministry of Intellectual Property, the entire disclosure of which is incorporated by reference herein.

### BACKGROUND OF THE INVENTION

### 1. Field

The present disclosure relates to a battery assembly, and more specifically, to a battery assembly with excellent safety.

### 2. Description of the Related Art

A secondary battery is a battery that converts electrical energy into chemical energy and stores the energy to be reused multiple times by charging and discharging. Secondary batteries have been widely used in various industries owing to their economical and eco-friendly characteristics. Particularly, of secondary batteries, lithium secondary batteries are widely utilized across industries, including mobile devices that require high-density energy.

The operating principle of lithium secondary batteries is an electrochemical oxidation-reduction reaction. In other words, electricity is generated by the movement of lithium ions and charged via the opposite process. In the case of lithium secondary batteries, the phenomenon in which lithium ions in a negative electrode escape and move to a positive electrode through an electrolyte and a separator is called discharging, and the opposite process is called charging.

Lithium secondary batteries may generate a lot of heat during the charging and discharging process. When the heat generated inside the lithium secondary battery is not quickly extinguished, the fire may spread to neighboring lithium secondary batteries, causing great damage. Therefore, one of the main challenges is to quickly extinguish the heat generated inside the lithium secondary battery and inhibit fire propagation.

For high capacity and high power characteristics, a plurality of lithium secondary batteries may be grouped together to be manufactured into a battery module or battery pack. In this case, a fire generated in any one of the plurality of lithium secondary batteries (battery cells) may cause the battery module or battery pack to burn out. Therefore, it is essential to prevent such risks.

### SUMMARY OF THE INVENTION

An embodiment of the present disclosure aims to provide a battery assembly with excellent stability.

An embodiment of the present disclosure aims to provide a battery assembly with improved thermal stability.

An embodiment of the present disclosure aims to provide a battery assembly capable of suppressing thermal runaway.

The battery assembly according to the present disclosure may be widely applied in the field of electric vehicles, battery charging stations, energy storage systems (ESS), and other green technologies such as photovoltaics and wind power that utilize batteries. Furthermore, the battery assembly according to the present disclosure may be used in eco-friendly mobility, including electric and hybrid vehicles to reduce air pollution and greenhouse gas emissions to prevent climate change.

An embodiment of the present disclosure may include: a housing having an accommodating space therein; a cell stack accommodated in the accommodating space inside the housing and including one or more battery cells; and a structure arranged between the battery cells and including a thermo-deformable member changing in volume at a predetermined temperature.

In an embodiment, the battery cell may include a tab for electrical connection with the outside, wherein the structure may be arranged between a tab and a tab of the battery cells arranged adjacent to each other.

In an embodiment, the thermo-deformable member may include a barbed portion increasing in volume at a predetermined temperature to damage the battery cell.

In an embodiment, the structure may include two materials with different thermal expansion rates.

In an embodiment, the thermo-deformable member may increase in volume at 120° C. or higher.

In an embodiment, the structure may include a first member having a relatively high thermal expansion rate and a second member having a relatively low thermal expansion rate, wherein the first member may be located inside the second member.

In an embodiment, the second member may be an insulating material.

In an embodiment, the structure may have one or more of cylindrical, linear, or spherical shapes.

In an embodiment, the structure may be linear, in which the first member having a relatively high thermal expansion rate is stacked on the second member having a relatively low thermal expansion rate and which has curved shape such that the first member is located inside.

In an embodiment, the battery assembly may include a binding member binding the first and second members having the curved shape.

In an embodiment, the binding member may include a thermoplastic resin, wherein the second member may further include a barbed portion having a needle-shaped end.

In an embodiment, the first member may include a first metal, the second member may include a second metal, and at least a portion of the structure may be coated with an insulating material.

In an embodiment, the structure may include a first member and a second member having different thermal expansion rates, wherein the second member may be provided in the form of a foldable cylinder that is folded in an origami fashion to be stretchable, and wherein the first member may be provided inside the second member.

In an embodiment, the second member may contract at a predetermined temperature, wherein the first member may protrude outwardly of the second member.

In an embodiment, the structure may include a first member and a second member having different thermal expansion rates, wherein the second member may be provided in a spherical shape, and wherein the first member may be provided inside the first member.

In an embodiment, the first member may further include a barbed portion provided at an end in a needle shape, wherein the first member may be connected clockwise or counterclockwise with respect to the center of the first member to be provided in a pinwheel shape.

In an embodiment, the battery cell may be pouch-shaped, angular, or cylindrical.

In an embodiment, the battery assembly may include a busbar assembly electrically connecting the battery cells, wherein the structure may be arranged in a space between the battery cell and the busbar assembly.

An embodiment of the present disclosure may provide a battery assembly with improved stability.

An embodiment of the present disclosure may provide a battery assembly with improved thermal stability.

An embodiment of the present disclosure may delay the onset of a fire in a battery assembly.

In an embodiment of the present disclosure, a battery cell and a thermo-deformable member located between the battery cells may expand in the event of a thermal runaway to cause damage to the battery cell. As a result, an electrolyte inside the battery cell may leak out and chemical reactions may be interrupted. Damaged battery cells may also act as a physical firewall, blocking the propagation of heat to neighboring battery cells. Thus, thermal runaway of the battery assembly may be prevented.

In an embodiment of the present disclosure, when a fire occurs in a battery assembly due to an external impact, overheating of the battery cells, or the like, heat propagation between the battery cells may be efficiently blocked to slow the spread of the fire.

### BRIEF DESCRIPTION OF THE DRAWINGS

FIG. 1 is a perspective view schematically illustrating a battery cell according to an embodiment of the present disclosure.

FIG. 2 is an exploded perspective view schematically illustrating a battery assembly according to an embodiment of the present disclosure.

FIG. 3 is a diagram schematically illustrating a cross-section of a battery assembly according to an embodiment of the present disclosure.

FIG. 4 is a diagram schematically illustrating a portion of a battery assembly according to an embodiment of the present disclosure.

FIG. 5 is a diagram schematically illustrating a structure according to an embodiment of the present disclosure.

FIG. 6 is a diagram schematically illustrating a structure according to another embodiment of the present disclosure.

FIG. 7 is a diagram to illustrate a mode of operation of a thermo-deformable member according to another embodiment of the present disclosure.

FIG. 8 is a diagram schematically illustrating a structure according to another embodiment of the present disclosure.

### DETAILED DESCRIPTION

Certain terms used herein are for convenience of description only and are not intended to limit the illustrated embodiments.

For example, expressions such as “same” and “identical to” indicate not only a state of being strictly identical, but also a state with the presence of a tolerance or a difference in the degree in which the same function is derived.

For example, expressions such as “in any direction,” “along any direction,” “side by side,” “perpendicularly,” “centered,” “concentric,” or “coaxial” that indicate a relative or absolute arrangement do not only strictly indicate such an arrangement, but also indicate a state of relative displacement by a tolerance, or by an angle or distance that the same function is obtained.

To describe the present disclosure, the following description will be set forth based on a spatial Cartesian coordinate system with the X, Y, and Z axes that are orthogonal to each other. Each axial direction (X-axis direction, Y-axis direction, Z-axis direction) refers to both directions along which the respective axis extends. The following references to the X-, Y-, and Z-directions are intended to describe for clear understanding of the present disclosure, and it is possible to define these directions differently depending on the reference.

The use of terms such as “first, second, and third” preceding components referred to herein is intended to avoid confusion as to the components to which they refer and is not intended to indicate any order, importance, or dominant-subordinate relationship among the components. For example, it is possible to implement an invention including only the second component without the first component.

The terminology used herein is for the purpose of describing specific embodiments and is not intended to limit the scope of the claims. As used in the description of the embodiments and the appended claims, singular forms are intended to include plural forms unless the context clearly indicates otherwise.

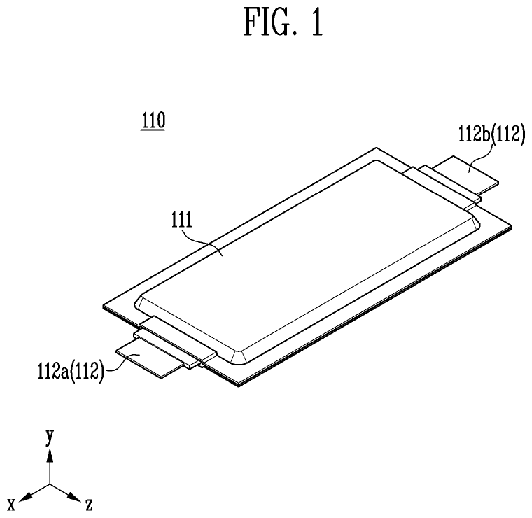

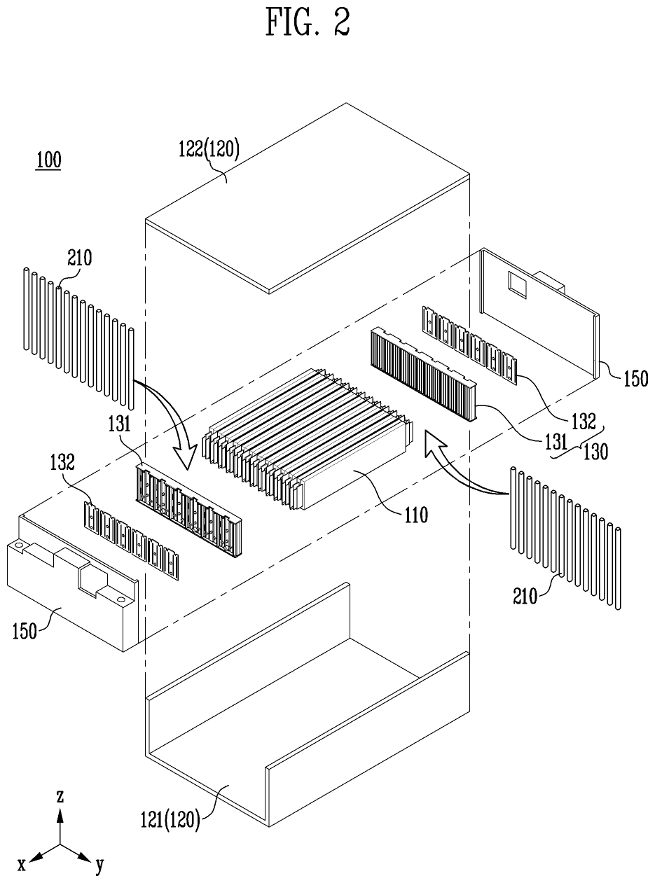

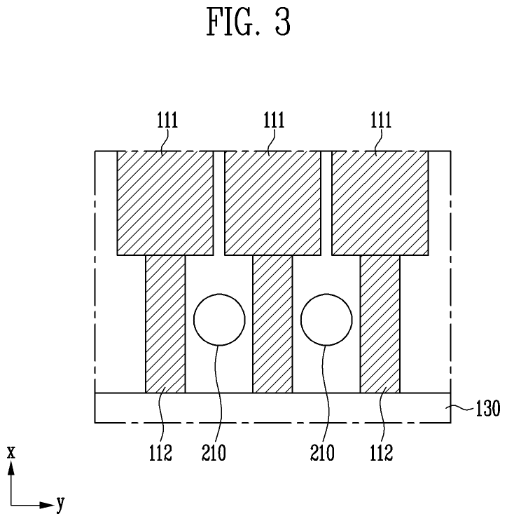

FIG. 1 is a perspective view schematically illustrating a battery cell according to an embodiment of the present disclosure, FIG. 2 is an exploded perspective view schematically illustrating a battery assembly according to an embodiment of the present disclosure, and FIG. 3 is a diagram schematically illustrating a cross-section of a battery assembly according to an embodiment of the present disclosure.

Referring to FIGS. 1 to 3, a battery assembly 100 according to an embodiment of the present disclosure may include: a housing 120 having an accommodating space therein; a cell stack accommodated in the accommodating space inside the housing and including one or more battery cells 110; and a structure 210 arranged between the battery cells 110 and including a thermo-deformable member changing in volume at a predetermined temperature.

According to an embodiment of the present disclosure, the battery assembly may be a variety of devices, including, but not limited to, such as a battery module, a battery pack, or an energy storage system (ESS) including one or more battery cells.

The battery cell 110 may refer to a secondary battery that may be repeatedly used by charging and discharging electrical energy. For example, the battery cell 110 may be, but is not limited to, a lithium cobalt cell, a lithium high nickel cell, a lithium iron phosphate cell, a lithium ion cell, a lithium polymer cell, a lithium sulfur cell, a nickel hydrogen cell, a nickel cadmium cell, a sodium cell, a all-solid-state cell, or the like.

The battery cell 110 may be categorized as a pouch-type secondary battery, a prismatic (or angular) secondary battery, or a cylindrical secondary battery depending on the shape of the housing. While a pouch-type secondary battery is shown herein as an example for convenience of description, it is not limited thereto, and the battery cell may be pouch-type, prismatic, or cylindrical.

Referring to FIG. 1, the battery cell 110 may include a body 111 and a tab 112. The body 111 may store and supply electrical energy. The body 111 may include a positive electrode and a negative electrode. In one example, the body 111 may include an electrode assembly formed by stacking a positive electrode, a negative electrode, and a separator, and an electrolyte. The separator may be interposed between the positive electrode and the negative electrode, and the electrolyte may include a liquid electrolyte. Alternatively, when the electrolyte is a solid electrolyte, or a gel electrolyte, or the like, the electrolyte may be interposed between the positive electrode and the negative electrode, and the separator may be omitted. The electrolyte may be a medium for transferring ions or current between the positive electrode and the negative electrode.

The positive electrode may include a positive electrode active material, and the negative electrode may include a negative electrode active material. The positive electrode active material may be a material into which lithium ions may be inserted and deintercalated, and the negative electrode active material may be a material into which lithium ions may be intercalated and deintercalated. Specifically, the positive electrode may be provided by coating a positive electrode active material on one side or the other of a positive electrode collector, and the negative electrode may be provided by coating a negative electrode active material on one side or the other of the negative electrode collector.

The tab 112 may be formed by protruding outwardly of the body 111. The tab 112 may be connected with the positive electrode and the negative electrode, respectively, and protrude outwardly of the body 111. The tab 112 may include a positive electrode tab 112a in connection with the positive electrode and a negative electrode tab 112b in connection with the negative electrode.

In an embodiment, the positive electrode tab 112a and the negative electrode tab 112b may protrude in the same direction or in opposite directions. Specifically, in an embodiment, the positive electrode tab 112a and the negative electrode tab 112b may protrude in opposite directions from each other. For example, referring to FIG. 1, the positive electrode tab 112a may protrude along the +X-direction, and the negative electrode tab 112b may protrude along the −X-direction.

The tab 112 may electrically connect the battery cell to the outside. The tab 112 may be connected to each of the positive electrodes and the negative electrodes of the body 111, respectively, to supply electrical energy stored in the body 111 to the outside or to receive electrical energy from the outside.

In an embodiment, the battery assembly 100 may refer to one or more battery cells 110 grouped together to protect them from external shock, heat, vibration, and the like, and to secure high power and high capacitance. For example, the battery assembly 100 may refer to a battery module or a battery pack. For ease of description, a battery module is described herein as an example of the battery assembly 100.

Referring to FIG. 2, in an embodiment, the battery assembly 100 may include a housing 120 that accommodates a cell stack including one or more battery cells 110. This may be to protect the battery cells 110 from external debris or impact and to allow them to be assembled as a single unit.

The housing 120 may include an accommodating body 121 accommodating the plurality of battery cells 110 and an accommodating cover 122 coupled to the accommodating body 121 to form a space in which the plurality of battery cells 110 are accommodated together with the accommodating body 121.

The accommodating body 121 may include an upwardly open opening, through which the plurality of battery cells 110 may be accommodated. The accommodating cover 122 may be coupled to the accommodating body 121 to close the opening.

In an embodiment, the battery assembly 100 may further include one or more end covers 150. The end covers 150 may be coupled to both sides of the accommodating body 121 to form one side and the other side of the accommodating space, respectively. For example, the end cover 150 may be coupled to the accommodating body 121 along the X-direction.

In an embodiment, the battery assembly 100 may form a hexahedron by the housing 120 and the end cover 150. This structure allows the battery cells 110 located inside to be efficiently protected from external impacts.

In an embodiment, the battery assembly 100 may include a busbar assembly 130. The busbar assembly 130 may include a busbar 132, and a busbar frame 131 in which the busbar is placed.

The busbar frame 131 may extend along a direction in which the plurality of battery cells 110 are stacked. The plurality of battery cells 110 may be positioned with their wide sides facing each other to improve the efficiency of the stacking. For example, referring to FIG. 2, a plurality of battery cells 110 may be stacked along the Y-direction.

The busbar frame 131 may be positioned to face the tab 112 of the battery cells 110. The busbar frame 131 may extend along the stacking direction as many times as the battery cells 110 are stacked, or there may be one or more busbar frames 131 along the stacking direction as many times as the battery cells 110 are stacked.

The busbar frames 131 may include a through-hole through which the tab 112 of the battery cell 110 is withdrawn. Through the through-hole, the tab 112 of the battery cell 110 may be withdrawn to an outer surface of the busbar frame 131.

The outer surface of the busbar frame 131 may be in a direction opposite to the direction toward the battery cell 110. The inner surface of the busbar frame 131 may be in a direction toward the battery cell 110. In FIG. 2, the outer surface of the busbar frame 131 may be in the +X-direction, and the inner surface of the busbar frame 131 may be in the −X-direction.

The busbar 132 may be placed on a surface of the busbar frame 131. In an embodiment, the busbar 132 may be placed on an outer surface of the busbar frame 131.

The battery cells 110 may be electrically connected by the busbar 132. The plurality of battery cells 110 may be electrically connected in series or in parallel, depending on how they are connected to the busbar 132.

The busbar 132 may include a slit through which the tab 112 of the battery cells may be withdrawn. The slit may allow the tab 112 of the battery cells 110 to be withdrawn. A plurality of battery cells 110 may be electrically connected by connecting the withdrawn tabs 112. The slits in the busbar may be provided at positions corresponding to through-holes in the busbar frame. Accordingly, the tabs 112 of the battery cells may be drawn through the busbar frame 131 and directly into the busbar 132.

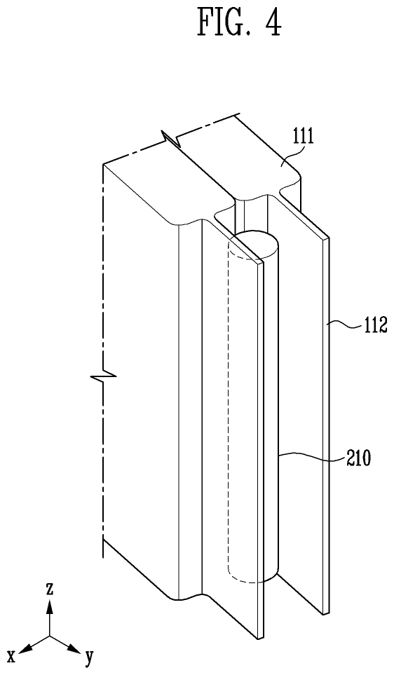

FIG. 4 is a diagram schematically illustrating a portion of a battery assembly according to an embodiment of the present disclosure.

Referring to FIGS. 3 and 4, a structure 210 including a thermo-deformable member may be accommodated in an accommodating space inside the housing. The structure 210 may be arranged in the space between the battery cells 110 and the busbar assembly 130.

In an embodiment, the structure 210 may be positioned between the battery cell 110 and the battery cell 110. Specifically, the structure 210 may be positioned between the tab 112 and the tab 112 of the battery cells 110 that are arranged adjacent to each other.

Although not shown, the tabs 112 of the battery cells may be withdrawn through through-holes in the busbar assembly 130. In this case, a space may be formed between the tab 112 and the tab 112 of the battery cells, and the structure 210 may be positioned in the space between the tab 112 and the tab 112 of the battery cells arranged adjacent to each other.

Specifically, in the battery cell 110, the thickness of the body 111 may be greater than the thickness of the tab 112. Thus, in the battery cells 110 stacked on top of each other, the neighboring tabs 112 are spaced apart from each other to form a space, and the structure 210 may be provided in the space.

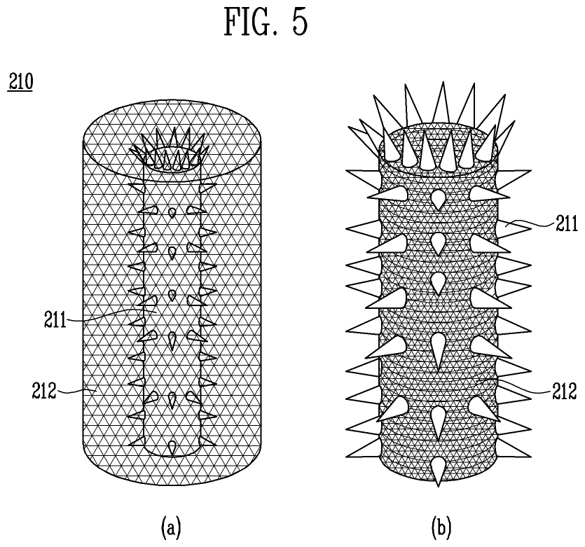

FIG. 5 is a diagram illustrating a structure 210 according to an embodiment of the present disclosure.

In an embodiment, the structure 210 may include a thermo-deformable member that changes in volume at a predetermined temperature. The thermo-deformable member may increase in volume at 120° C. or higher.

In an embodiment, the thermo-deformable member may increase in volume as the temperature of the battery cell increases. When heat is generated in the battery cell and the temperature rises, the thermo-deformable member may expand or contract to change the arrangement and shape of the battery cells that are stacked on top of each other. Specifically, when heat is generated in the battery cell and the temperature rises, the thermo-deformable member may expand in volume. Thus, by preventing thermal runaway of the battery cell, the safety of the battery cell may be improved. The thermo-deformable member may include a barbed portion that increases in volume (size) at a predetermined temperature to damage the battery cell. The thermo-deformable member may include any one of the first member 211 and the second member 212.

In an embodiment, the structure 210 may include two materials with different thermal expansion rates. It may include a first member 211 having a relatively high thermal expansion rate and a second member 212 having a thermal expansion rate that is relatively lower than the first member 211. The first member 211 may be located inside the second member 212.

The thermal expansion rate or coefficient of thermal expansion is the ratio between the thermal expansion and temperature of an object under constant pressure. The lower the coefficient of thermal expansion, the lower the tendency of the object to change in size with temperature. When heat is generated in the battery cell, the first member 211 may increase in volume due to a relatively high thermal expansion rate. The first member 211 having a relatively high thermal expansion rate may be arranged inside a second member 212 having a relatively low thermal expansion rate.

The first member 211 may expand at a thermal expansion threshold temperature and protrude from the outer surface of the second member 212. The first member 211 may include a barbed portion having a needle-shaped end to protrude outwardly of the body 111 of the battery cell. The barbed portion may be shaped like an arrowhead having an approximately triangular cross-section.

The barbed portion may be provided inside the second member 212 at normal operating temperature of the battery cell, and when heat is generated by the battery cell to reach a thermal expansion threshold temperature, it may expand to protrude from the outer surface of the second member 212. The first member 211 protruding from the outer surface of the second member 212 may apply pressure onto the neighboring battery cells 110, space apart between the battery cells 110, or penetrate the body 111 of the battery cells.

In an embodiment, the first member 211 may have a thermal expansion threshold temperature of 120° C. or higher, or 150° C. or higher, or 200° C. or higher. Specifically, the thermal expansion threshold temperature of the first member 211 may be from 200° C. to 400° C.

In an embodiment, the first member 211 may include a first metal. The first metal may include one or more of aluminum (Al), nickel (Ni), manganese (Mn), iron (Fe), copper (Cu), and molybdenum (Mo). Specifically, the first metal may be any one of an alloy of aluminum (Al), nickel (Ni), manganese (Mn), and iron (Fe), or an alloy of nickel (Ni), manganese (Mn), and copper (Cu), or an alloy of nickel (Ni), molybdenum (Mo), and iron (Fe), aluminum 1100, or carbon steel 1020.

By way of example, but not limited to, the second member 212 may be a material having insulating properties. Specifically, the second member 212 may be an insulating material. By way of example, but not limited to, the second member 212 may be a polyolefin-based heat shrinkable tube, polypropylene, polyvinyl chloride, or acrylic-based resin.

In accordance with the present disclosure, the structure may include one or more of cylindrical, linear, or spherical shapes. In the following, structures according to each of these shapes will be described in separate embodiments.

In an embodiment, the structure 210 may be formed in a cylindrical shape, but is not limited to. In an embodiment, the second member 212 may have a cylindrical shape, and the first member 211 may be arranged inside the cylindrical shape.

For example, as shown in FIG. 5, in the structure 210, the second member 212 may be provided in the form of foldable cylinder that is folded in an origami fashion to be stretchable. And the first member may be provided inside the second member. Specifically, the second member 212 may contract at a predetermined temperature, and the first member 211 may protrude outwardly of the second member 212.

The second member 212 may include a material having a relatively low thermal expansion rate compared to the first member 211.

In an embodiment, the second member 212 may contract as the temperature of the battery cell 110 increases. The thermal contraction threshold temperature of the second member 212 may be 200° C. or less, 150° C. or less, 120° C. or less.

When heat is generated in the battery cell and the temperature thereof increases to a thermal expansion threshold temperature of the first member 211, the first member 211 may expand and protrude outwardly of the second member 212. The first member 211 protruding from the outer surface of the second member 212 may apply pressure onto the tab 112 of the battery cell, thereby breaking the electrical connection between the tab 112 and the busbar assembly 130. Further, it may cause damage to the battery cell 110. Damage to the body of the battery cell 110 may cause the electrolyte inside to leak out and the chemical reactions to cease. A damaged battery cell may act as a physical firewall, blocking heat from transferring to neighboring battery cells. Thus, thermal runaway of the battery assembly may be prevented.

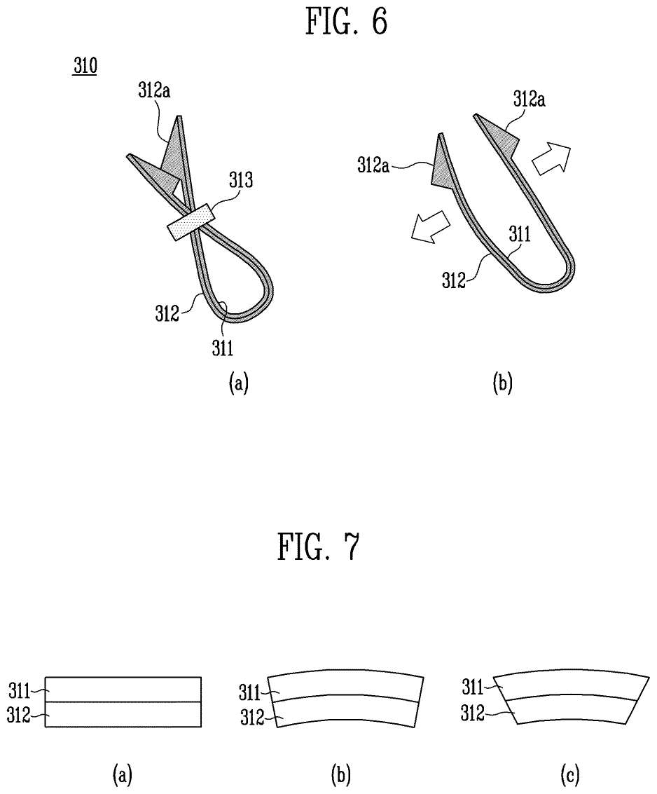

FIG. 6 is a diagram schematically illustrating a structure according to another embodiment of the present disclosure. FIG. 7 is a diagram to illustrate the mode of operation of a thermo-deformable member according to another embodiment of the present disclosure.

As shown in FIG. 6, the structure 310 may include a first member 311 having a relatively high thermal expansion rate and a second member 312 having a relatively low thermal expansion rate.

The structure 310 may be provided in the form of a clad in which the second member 312 having a relatively low thermal expansion rate is stacked on the first member 311 with a relatively high thermal expansion rate, and may be linear or curved such that the first member 311 is located inside. Specifically, the first member 311 and second member 312 may be provided linearly and stacked, and then provided in a curved shape such that the first members 311 face each other. More specifically, the structure may be linear, in which the first member having a relatively high thermal expansion rate may be stacked on the second member having a relatively low thermal expansion rate, and may have curved shape such that the first member may be located inside.

In an embodiment, the structure 310 may further include a binding member 313. The binding member 313 may engage the first member 311 and the second member 312, which are provided in a curved shape, to have the first and second members 311, 312 fixed in the curved shape.

The structure 310 may be provided in a U-shape in which the first members 311 face each other, with the shape fixed by the binding member 313. The structure 310, fixed by the binding member 313, may be positioned between tabs of battery cells neighboring each other.

When the temperature of the battery cell rises, the binding member 313 may melt, thereby disengaging the first and second members 311, 312. When the binding member 313 melts, the binding structure of the linear structure 310 may be loosened and the volume of the first member 311 may expand. Specifically, as the temperature of the battery cell increases, the first member 311, which is arranged inside and has a large coefficient of thermal expansion, may expand, causing the ends to expand to both sides in a curved shape.

In an embodiment, the binding member 313 may include a thermoplastic resin. As the thermoplastic resin, the polymethylmethacrylate-based, ABS resin-based, nylon, PLA resin-based, polybenzimidazole (PBI) resin-based, polycarbonate-based, polyethersulfone-based, polyoxymethylene-based, polyethylene (PE), polyoxyphenylene (PPO)-based, polyphenylene (PPS)-based, polypropylene (PP)-based, polyvinyl chloride (PVC)-based, PTFE-based resins may be used.

In an embodiment, the second member 312 may have a negative coefficient of thermal expansion. Accordingly, the first member 311 arranged inside may expand and the second member 312 arranged on the outside may contract when the temperature of the battery cell increases. Accordingly, the bent structure 310 may be unfolded.

In an embodiment, the second member 312 may include a barbed portion 312a. The barbed portion 312a may include a needle-shaped end and may be provided at ends of the second member 312, respectively. When the binding member 313 melts, the structure 310 whose shape is fixed in the U-shape unfolds to both sides, and the barbed portion 312a may come in contact with the adjacent battery cell 110 and penetrate the body 111 of the battery cell.

FIG. 7 schematically illustrates the expansion of the first member 311 and the second member 312 in accordance with a temperature increase and a change in shape thereby.

In an embodiment, the first member 311 may include a first metal. The first metal may include, but not limited to, one or more of aluminum (Al), nickel (Ni), manganese (Mn), iron (Fe), copper (Cu), and molybdenum (Mo). Specifically, the first metal may be any one of an alloy of aluminum (Al), nickel (Ni), manganese (Mn), and iron (Fe), or an alloy of nickel (Ni), manganese (Mn), and copper (Cu), or an alloy of nickel (Ni), molybdenum (Mo), and iron (Fe).

In an embodiment, the second member 312 may include a second metal, wherein the second metal may be steel, an alloy of nickel (Ni) and iron (Fe), or a steel including carbon.

More specifically, the first member 311 may be aluminum and the second member 312 may be carbon steel.

Further, but not limited to, any material having different thermal expansion rates at the thermal runaway temperature of the battery cell may be used.

When the first member 311 and the second member 312 are metal, the structure 310 may be coated with an insulating material.

When thermal runaway occurs in the battery cell, the structure 310 may expand to change the arrangement and shape of the battery cell. In an embodiment, the structure 310 may have resiliency as the binding member 313 melts with the increase in the temperature, causing the structure to be fixed in a U-shape. When the bent shape of the structure 310 unfolds, the structure 310 may apply pressure onto the tabs of adjacent battery cells. This may cause the electrical connection between the tabs and the busbar assembly to break. It may also cause damage to the battery cells. When the body of the battery cell is damaged, the electrolyte therein may leak out, and the chemical reaction may be disrupted. A damaged battery cell may act as a physical firewall, blocking the transfer of heat to neighboring battery cells. This prevents thermal runaway of the battery assembly.

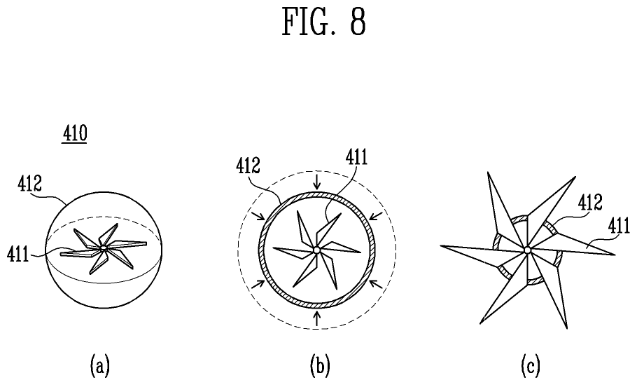

FIG. 8 is a diagram schematically illustrating a structure according to another embodiment of the present disclosure.

In an embodiment, the structure 410 may include a first member 411 having a relatively high thermal expansion rate and a second member 412 having a relatively low thermal expansion rate. The first member 411 having a relatively high thermal expansion rate may be arranged within the second member 412 having a relatively low thermal expansion rate.

In an embodiment, the structure 410 may have a spherical shape. In an embodiment, the second member 412 may have a spherical shape, and the first member 411 may be arranged inside the spherical shape.

As the temperature of the battery cell increases, the first member 411 may expand in size. When the temperature is raised by the battery cell to a thermal expansion threshold temperature of the first member 411, the first member 411 may expand and protrude from the outer surface of the second member 412.

The first member 411 may include a barbed portion having a needle-shaped end capable of penetrating the body of the battery cell 110. Specifically, the first member 411 may be provided in a pinwheel shape with one or more the barbed portions connected clockwise or counterclockwise about a center thereof. More specifically, the barbed portion may be provided at an end in a needle shape, and the first member 411 may be connected clockwise or counterclockwise about the center of the first member 411 to be provided in a pinwheel shape.

In the first member 411, the barbed portion may be in the second member 412 at normal operating temperature of the battery cell, but may expand at a thermal expansion threshold temperature to protrude from the outer surface of the second member 412, apply pressure on adjacent battery cells, and penetrate the body of the battery cell.

In an embodiment, the second member 412 may have a negative coefficient of thermal expansion. Accordingly, the externally arranged second member 412 may contract as the temperature of the battery cell increases. Accordingly, the internally arranged first member 411 may protrude outwardly.

In an embodiment, the first member 411 may include a first metal. The first metal may be one or more of aluminum (Ai), nickel (Ni), manganese (Mn), iron (Fe), copper (Cu), and molybdenum (Mo). Specifically, the first metal may be any one of an alloy of nickel (Ni), manganese (Mn), and iron (Fe), or an alloy of nickel (Ni), manganese (Mn), and copper (Cu), or an alloy of nickel (Ni), molybdenum (Mo), and iron (Fe).

In an embodiment, the second member 412 may include a material with a relatively low thermal expansion rate. In an embodiment, the second member 412 may contract as the temperature of the battery cell increases. The thermal contraction threshold temperature of the second member 412 may be 200° C. or less, 150° C. or less, or 120° C. or less.

By way of example, but not limited to, the second member 412 may be a material having insulating properties. By way of example, but not limited to, the second member 412 may be a polyolefin-based heat shrinkable tube, polypropylene, polyvinyl chloride, or acrylic-based resin.

When thermal runaway occurs in the battery cell, the first member 411 may expand, causing changes in the arrangement and shape of the battery cell. In an embodiment, when the first member 411 expands in response to an increase in temperature, it may apply pressure onto neighboring battery cells. This may result in electrical disconnection of the tab and busbar assembly. It may also cause damage to the body of the battery cell. Damage to the body of the battery cell may cause the electrolyte inside to leak out and disrupt the chemical reaction. A damaged battery cell may act as a physical firewall, blocking the transfer of heat to neighboring battery cells. This prevents thermal runaway of the battery assembly.

An embodiment of the present disclosure may be a battery pack including one or more battery modules. The composition and features of the battery modules are as described above. In addition to the battery modules, the battery pack may further include a pack case to store the battery modules, various devices to control the charging and discharging of the battery modules, such as a battery management system (BMS), current sensors, fuses, and the like.

The present disclosure may be practiced in various modifications, and the scope of the disclosure is not limited to the embodiments described above. Accordingly, any variations should be considered to fall within the scope of the disclosure when including components of the patent claims of the present disclosure.

What is claimed is:

1. A battery assembly comprising:
a housing having an accommodating space therein;
a cell stack accommodated in the accommodating space and including one or more battery cells; and
a structure arranged between the battery cells and including a thermo-deformable member changing in volume at a predetermined temperature.

2. The battery assembly according to claim 1, wherein the battery cell includes tab for electrical connection with the outside, wherein the structure is arranged between a tab and a tab of the battery cells arranged adjacent to each other.

3. The battery assembly according to claim 1, wherein the thermo-deformable member includes a barbed portion increasing in volume at a predetermined temperature to damage the battery cell.

4. The battery assembly according to claim 1, wherein the structure includes two materials with different thermal expansion rates.

5. The battery assembly according to claim 1, wherein the thermo-deformable member increases in volume at 120° C. or higher.

6. The battery assembly according to claim 1, wherein the structure includes a first member having a relatively high thermal expansion rate and a second member having a relatively low thermal expansion rate, and
wherein the first member is located inside the second member.

7. The battery assembly according to claim 6, wherein the second member is an insulating material.

8. The battery assembly according to claim 1, wherein the structure has one or more of cylindrical, linear, or spherical shapes.

9. The battery assembly according to claim 1, wherein the structure is linear, in which the first member having a relatively high thermal expansion rate is stacked on the second member having a relatively low thermal expansion rate and which has curved shape such that the first member is located inside.

10. The battery assembly according to claim 9, further comprising a binding member binding the first and second members having the curved shape.

11. The battery assembly according to claim 9, wherein the binding member includes a thermoplastic resin, and
wherein the second member further includes a barbed portion having a needle-shaped end.

12. The battery assembly according to claim 9, wherein the first member includes a first metal,
wherein the second member includes a second metal, and
wherein at least a portion of the structure is coated with an insulating material.

13. The battery assembly according to claim 1, wherein the structure includes a first member and a second member having different thermal expansion rates,
wherein the second member is provided in the form of a foldable cylinder that is folded in an origami fashion to be stretchable, and
wherein the first member is provided inside the second member.

14. The battery assembly according to claim 11, wherein the second member contracts at a predetermined temperature, and
wherein the first member protrudes outwardly of the second member.

15. The battery assembly according to claim 1, wherein the structure includes a first member and a second member having different thermal expansion rates,
wherein the second member is provided in a spherical shape, and
wherein the first member is provided inside the second member.

16. The battery assembly according to claim 15, wherein the first member further includes a barbed portion provided at an end in a needle shape, and
wherein the first member is connected clockwise or counterclockwise with respect to the center of the first member to be provided in a pinwheel shape.

17. The battery assembly according to claim 1, wherein the battery cell is pouch-shaped, angular, or cylindrical.

18. The battery assembly according to claim 1, comprising a busbar assembly electrically connecting the battery cells,
wherein the structure is arranged in a space between the battery cell and the busbar assembly.
